(19) United States
(12) Patent Application Publication
(10) Pub. No.: US 2021/0103999 A1
(43) Pub. Date: Apr. 8, 2021

(54) SYSTEMS AND METHODS FOR ENHANCED COURT DOCUMENT NAVIGATION

(71) Applicant: Richard Clifford Reuben, St. Louis, MO (US)

(72) Inventor: Richard Clifford Reuben, St. Louis, MO (US)

(21) Appl. No.: 17/065,299

(22) Filed: Oct. 7, 2020

Related U.S. Application Data
(60) Provisional application No. 62/973,443, filed on Oct. 7, 2019.

(51) Int. Cl. G06Q 50/18; G06Q 30/02; G06F 16/93; G06F 16/9035; G06F 40/174

(52) U.S. Cl. CPC G06Q 50/18; G06Q 30/0206; G06F 40/174; G06F 16/9035; G06F 16/93

(57) ABSTRACT

A court document navigation (CDN) computer device is provided. The CDN computer device receives ticket information about a ticket and an image of the ticket, generates an attorney fee based on the ticket information, receives an indication of a fee payment from the user for the attorney fee via the user computer device, generates an attorney client agreement based on the ticket information, transmits the attorney client agreement to the user, receives a user signature on the attorney client agreement, generates a court entry filing for an attorney based on the ticket information, generates an initial contact request for the prosecutor based on the ticket information, submits to the prosecutor the initial contact request for the prosecutor, receives a prosecutor response, and transmits the prosecutor response to the user.

### CROSS REFERENCE TO RELATED APPLICATIONS

This application claims priority to U.S. Provisional Patent Application No. 62/973,443, filed Oct. 7, 2019, entitled “TicketTamer,” which is hereby incorporated by reference in its entirety.

### BACKGROUND

The field of the invention relates generally to managing and filing court documents, and, more specifically, for providing an enhanced interface for providing a user access to justice and the court systems.

Many individuals have interactions with the judicial system; however, due to the complexities and variations between different jurisdictions, these interactions can be overwhelming. Some potentially simple interactions, such as paying a speeding ticket, can turn into significantly more as the average individual does not understand all of the steps required to process the speeding ticket in an efficient manner. Furthermore, those individuals with access to legal advice can generally get additional benefits, such as reduced sentences or fines, fewer points on their driving record, or reduced ticket charges. As improving access to justice for the average individual is desired, a method to improve an individual's ability to navigate the court systems would be advisable.

### BRIEF DESCRIPTION

In some aspects, a court document navigation (CDN) computer device is provided. The CDN computer device includes at least one processor in communication with at least one memory device. The at least one processor is programmed to receive, from a user computer device, ticket information about a ticket and an image of the ticket. The at least one processor is also programmed to generate an attorney fee based on the ticket information. The at least one processor is further programmed to receive an indication of a fee payment from the user for the attorney fee via the user computer device. In addition, the at least one processor is programmed to generate an attorney client agreement based on the ticket information. Moreover, the at least one processor is programmed to transmit, to the user computer device, the attorney client agreement to the user. Furthermore, the at least one processor is programmed to receive, from the user computer device, a user signature on the attorney client agreement. In addition, the at least one processor is also programmed to generate a court entry filing for an attorney based on the ticket information. In addition, the at least one processor is also programmed to generate an initial contact request for the prosecutor based on the ticket information. In addition, the at least one processor is further programmed to transmit, to the prosecutor, the initial contact request for the prosecutor. Moreover, the at least one processor is also programmed to receive, from the prosecutor, a prosecutor response. Moreover, the at least one processor is further programmed to transmit, via the user computer device, the prosecutor response to the user.

In some further aspects, a method for navigating court documents is provided. The method is implemented by at least one processor in communication with at least one memory device. The method includes receiving, from a user computer device, ticket information about a ticket and an image of the ticket. The method also includes generating an attorney fee based on the ticket information. The method further includes receiving a an indication of a fee payment from the user for the attorney fee via the user computer device. In addition, the method includes generating an attorney client agreement based on the ticket information. Moreover, the method includes transmitting, to the user computer device, the attorney client agreement to the user. Furthermore, the method includes receiving, from the user computer device, a user signature on the attorney client agreement. In addition, the method also includes generating a court entry filing for an attorney based on the ticket information. In addition, the method further includes generating an initial contact request for the prosecutor based on the ticket information. Moreover, the method also includes submitting, to the prosecutor, the initial contact request for the prosecutor. Moreover, the method further includes receiving, from the prosecutor, a prosecutor response. Furthermore, the method also includes transmitting, via the user computer device, the prosecutor response to the user.

In still further aspects, a system is provided. The system includes a user computer device include a processor in communication with a memory device. The system also includes an attorney computer device comprising a processor in communication with a memory device. The system further includes a database including jurisdiction information. In addition, the system includes a court document navigation (CDN) computer device including a processor in communication with a memory. The CDN computer device is in communication with the user computer device, the attorney computer device, and the database. The processor of the CDN computer device is programmed to receive, from the user computer device, ticket information about a ticket and an image of the ticket. The processor of the CDN computer device is also programmed to retrieve, from the database, jurisdiction information based on the ticket information. The processor of the CDN computer device is further programmed to generate an attorney fee based on the ticket information and the jurisdiction information. In addition, the processor of the CDN computer device is programmed to receive an indication of a fee payment from the user for the attorney fee via the user computer device. Moreover, the processor of the CDN computer device is programmed to generate an attorney client agreement based on the ticket information. Furthermore, the processor of the CDN computer device is programmed to transmit, to the attorney computer device, the attorney client agreement to an attorney. In addition, the processor of the CDN computer device is also programmed to receive, from the attorney computer device, an attorney signature on the attorney client agreement. In addition, the processor of the CDN computer device is further programmed to transmit, to the user computer device, the attorney client agreement to the user. Moreover, the processor of the CDN computer device is also programmed to receive, from the user computer device, a user signature on the attorney client agreement. Moreover, the processor of the CDN computer device is further programmed to generate a court entry filing for the attorney based on the ticket information. Furthermore, the processor of the CDN computer device is also programmed to generate an initial contact request for the prosecutor based on the ticket information. Furthermore, the processor of the CDN computer device is further programmed to submit, to the prosecutor, the initial contact request for the prosecutor. The processor of the CDN computer device is also programmed to receive a prosecutor response. The processor of the CDN computer device is further programmed to transmit, via the user computer device, the prosecutor response to the user.

### BRIEF DESCRIPTION OF THE DRAWINGS

The Figures described below depict various aspects of the systems and methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present embodiments are not limited to the precise arrangements and are instrumentalities shown, wherein:

FIG. 1 illustrates a graphical view of an exemplary enhanced court document navigation system in accordance with one embodiment of the disclosure.

FIGS. 2A-2C illustrate an exemplary process for using the enhanced court document navigation computer system shown in FIG. 1.

FIG. 3 illustrates another view of an enhanced court document navigation system in accordance with one embodiment of the disclosure.

FIG. 4 illustrates an example configuration of a user computer device used in the system shown in FIG. 1 and the system shown in FIG. 3, in accordance with one example of the present disclosure

FIG. 5 illustrates an example configuration of a server computer device used in the system shown in FIG. 1 and the system shown in FIG. 3, in accordance with one example of the present disclosure.

### DETAILED DESCRIPTION

The implementations described herein relate to systems and methods for managing and filing court documents and, more specifically, providing an enhanced interface for providing a user access to justice and the court systems. More specifically, a court document navigation (“CDN”) computer device is provided for handling court documents and other care details. The embodiments described herein can assist in the user in dealing with attorneys, jurisdictions, and court documents to resolve matters.

The systems and processes are not limited to the specific embodiments described herein. In addition, components of each system and each process can be practiced independent and separate from other components and processes described herein. Each component and process also can be used in combination with other assembly packages and processes.

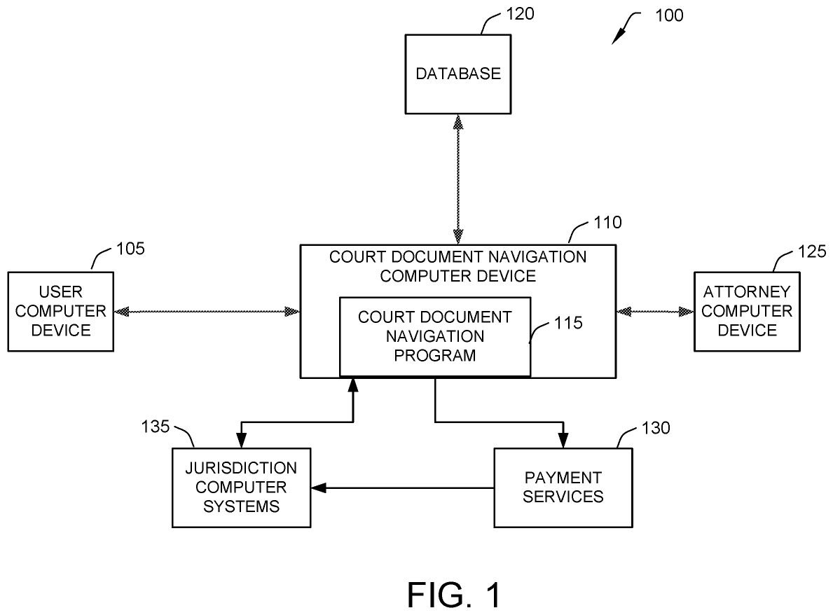

FIG. 1 illustrates a graphical view of an exemplary enhanced court document navigation (CDN) system 100 in accordance with one embodiment of the disclosure. In the exemplary embodiment, the CDN system 100 includes a plurality of user computer devices 105 in communication with a court document navigation (CDN) computer device 110 executing a court document navigation program 115. In the exemplary embodiment, the CDN program 115 is provided to users and/or attorneys as a webservice or an application on the user computer device 105 that communicates with the CDN program 115.

In some embodiments, the CDN computer device 110 is a server or other centralized computer device that allows user computer devices 105 to communicate with it. The user loads an application onto their user computer device 105 which allows the user computer device 105 to access the CDN program 115 on the CDN computer device 110. In other embodiments, the user accesses the CDN program 115 through a webpage that allows access to the CDN program 115. Furthermore, the CDN program 115 is capable of sending notifications to the user computer device 105. These notifications can include, but are not limited to, text messages (SMS and MMS), phone calls, voice messages, push notification messages, emails, and other forms of communication.

In the exemplary embodiment, the CDN computer device 110 is in communication with one or more databases 120. Database 120 may be integrated with CDN program 115 and/or CDN computer device 110. Database 120 may also be remote from CDN program 115 and/or CDN computer device 110. In the exemplary embodiment, the database 120 stores information about different jurisdictions, different court documents, and different preferences of members of the court in the different jurisdictions.

In the exemplary embodiment, the CDN computer device 110 is also in communication with one or more attorney computer devices 125. Each attorney computer device 125 is associated with an attorney and allows the attorney to communicate with the CDN program 115 on the CDN computer device 110. In some embodiments, multiple attorney computer devices 125 can be associated with a single attorney. For example, the attorney may access the CDN program 115 via a desktop computer, a laptop computer, a tablet, and/or a smartphone. Furthermore, the CDN program 115 is capable of sending notifications to the attorney computer device 125. These notifications can include, but are not limited to, text messages, phone calls, push messages, emails, and other forms of communication.

In some embodiments, the CDN computer device 110 is in communication with one or more payment services 130 that allow the user to transfer funds to the attorney. In these examples, the payment services 130 collect funds from the user, such as to pay the attorney and/or any fines or fees. The collected funds are then stored in an operating account, until the attorney transfers the funds to one or more accounts associated with the attorney and/or the appropriate jurisdiction to pay for any fines or fees. The payments to courts are then made by an employee, third party vendor, or a software system itself.

Furthermore, the CDN computer device 110 is in communication with one or more jurisdiction computer systems 135. These are computer systems that are associated with a legal jurisdiction. These can be, but are not limited to, systems and/or services that allow the attorney to remotely enter into a case, submit documents to the jurisdiction, and/or read rules and rules changes. For example, a jurisdiction computer system 135 may include information about changes to a court's schedule, such as due to a weather event. In some embodiments, the CDN computer device 110 can retrieve this information from the jurisdiction computer system 135. Furthermore, the CDN computer system 110 can determine when there are changes to the rules and guidelines of a jurisdiction based on information on one or more jurisdiction computer systems 135.

While the enclosed description highlights systems and methods for the navigation of court documents associated with traffic tickets, one having skill in the art would understand that the court documents navigated by the CDN computer device 110 and CDN program 115 could include, but are not limited to, divorce documents, wills, expungements, general contracts, and demand letters, among other legal services.

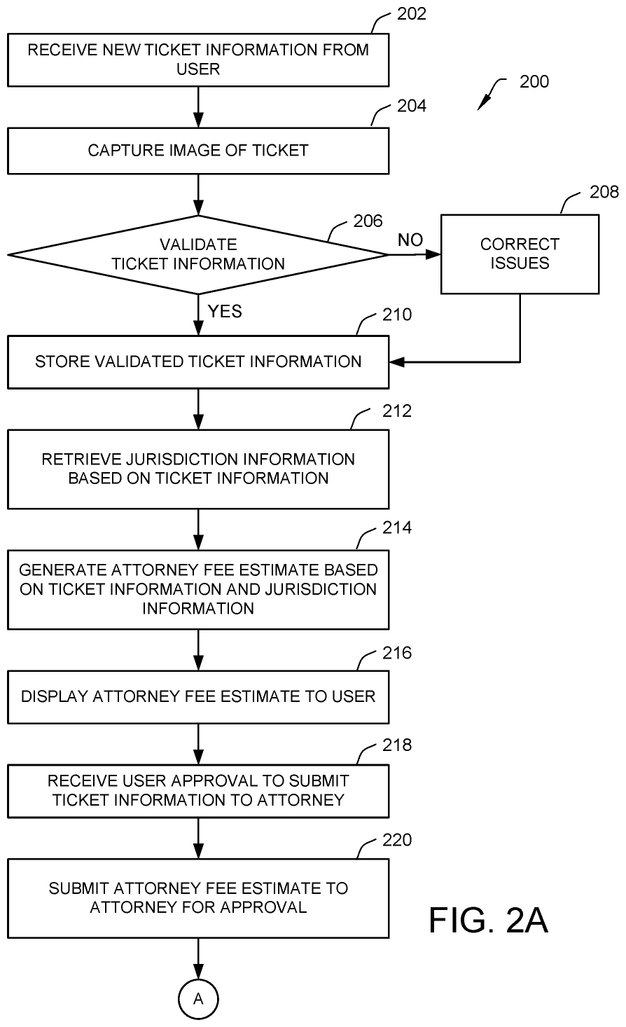

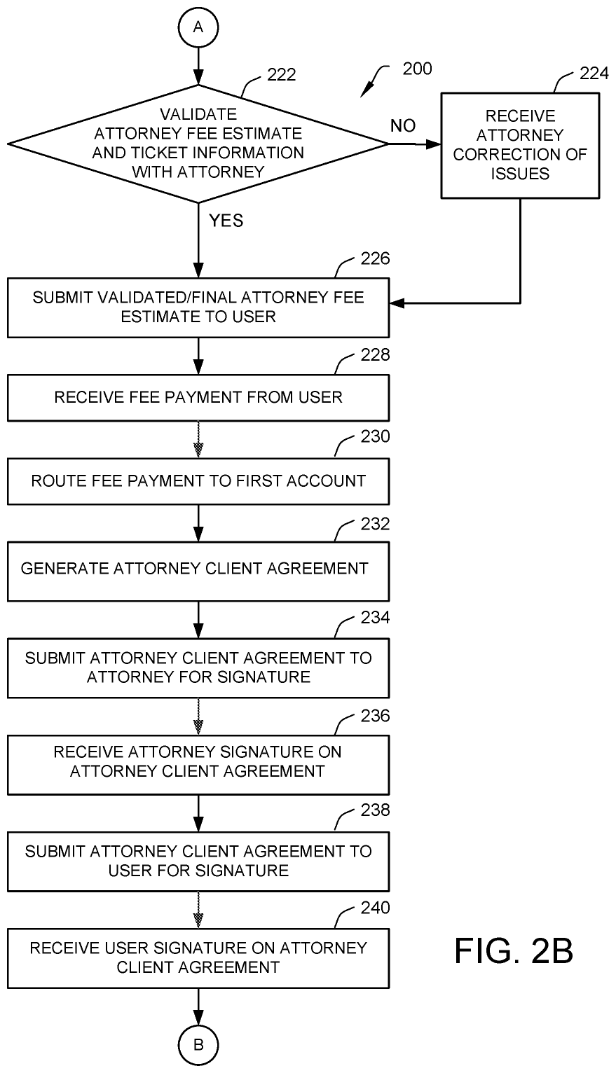

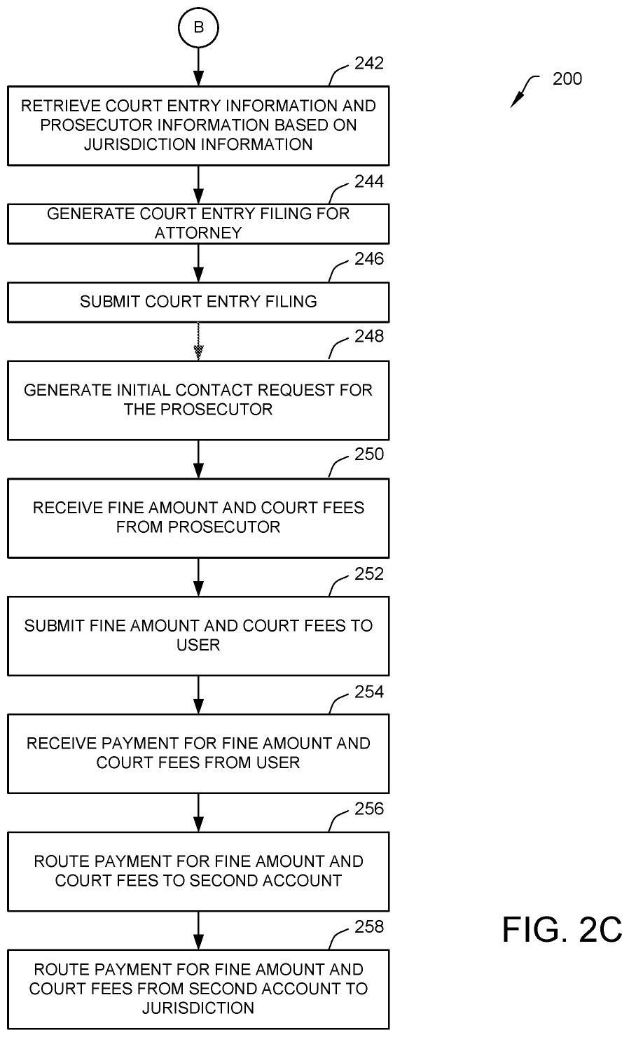

FIGS. 2A-2C illustrate an exemplary process 200 for using the enhanced court document navigation (CDN) computer system 100 (shown in FIG. 1). In the exemplary embodiment, the steps of process 200 are performed by one or more of the CDN computer device 110, the user computer device 105, and the attorney computer device 125 (all shown in FIG. 1), all of which may be executing a portion of the CDN program 115 (shown in FIG. 1). In the exemplary embodiment, process 200 is a process for handling a court document. In this example embodiment, the process 200 is for handling a traffic ticket. However, in other embodiments, the process 200 could be for handling other court documents, such as, but not limited to, divorce documents, wills, expungements, general contracts, and demand letters, among other legal services.

In the exemplary embodiment, the CDN computer device 110 receives 202 new ticket information from a user via the user computer device 105. In this embodiment, the user computer device 105 receives 202 the new ticket information through a graphical user interface that the user computer device 105 displays to the user. In some embodiments, the user computer device 105 stores the new ticket information on the user computer device 105. In other embodiments, the user computer device 105 transmits the new ticket information to the CDN computer device 110 for storage. The new ticket information can include, but is not limited to, user name, state, court for the ticket, ticket number, violation, court date, high speed (Y/N), and warrant.

The CDN computer device 110 captures 204 an image of the ticket via the user computer device 105. In some embodiments, the user manually takes a picture of the ticket and uploads the image to the CDN computer device 110. In other embodiments, the CDN computer device 110 guides the user in how to capture 204 the image of the ticket and the CDN computer device 110 uploads the image of the ticket. In some embodiments, the CDN computer device 110 validates the image of the ticket to ensure that the image is in focus and has proper lighting so that the ticket can be read. If the image of the ticket is not of sufficient quality, the CDN computer device 110 can instruct the user via the user computer device 105 to capture 204 another image of the ticket.

The CDN computer device 110 validates 206 the ticket information. The CDN computer device 110 performs optical character recognition on the image of the ticket and retrieves information from the image of the ticket. Then the CDN computer device 110 compares the information retrieved from the image of the ticket to the new ticket information provided by the user in Step 202. If the information on the image matches the provided information, the ticket information is validated. If the information on the image does not match the provided information, the CDN computer device 110 corrects 208 the issues and/or discrepancies. For example, the user may have entered the court date incorrectly and the CDN computer device 110 corrects 208 the issue. In some embodiments, the CDN computer device 110 asks the user to confirm any corrections. The CDN computer device 110 stores 210 the validated ticket information.

The CDN computer device 110 retrieves 212 jurisdiction information based on the validated ticket information. In the exemplary embodiment, the jurisdiction information is retrieved from the database 120 (shown in FIG. 1) using the court information provided with the ticket information. The jurisdiction information includes, but is not limited to, specific details associated with the jurisdiction including actions that an attorney is required to do to process the ticket. For example, one jurisdiction may require an appearance at the courthouse or a copy of the user's driving record to be submitted. This jurisdictional information is then used with the validated ticket information for the CDN computer device 100 to generate 214 an attorney fee estimate. The attorney fee estimate is an unconfirmed estimate of how much it would cost in attorney's fees to process the ticket. For example, processing the ticket may include a base amount, any additional fees, and if the ticket is due in a few days, there may a further rush fee. The fee estimate may be based on additional details, such as, but not limited to, outstanding warrants, extensions or continuances, appearance fee, rush fee (within 7 days of the court date or after), expedited fee (ticket submitted within three days of the court date), high speed ticket, and if a driving record needs to be submitted. The attorney fee estimate is then displayed 216 to the user on the user computer device 105.

After the user views the attorney fee estimate, the user computer device 105 can then receive 218 user approval to submit the ticket information to the attorney.

The CDN computer device 110 submits 220 the attorney fee estimate to the attorney for confirmation of the estimated attorney fee. In the exemplary embodiment, the CDN computer device 110 receives 218 the user approval and then submits 220 the ticket information and attorney fee estimate to the attorney computer device 125 for confirmation. In some embodiments, the CDN computer device 110 transmits one or more notifications to the attorney when the ticket is submitted 220 to the attorney. In these embodiments, the additional notifications notify that a ticket has been received 218 from a user and needs to be reviewed. This ensures that the attorney pays prompt attention to the ticket and the user. In some embodiments, there may be a plurality of attorneys to review the ticket information. In these embodiments, the CDN computer device 110 may determine which attorney to submit 220 the ticket to based on one or more factors, such as, but not limited to, availability, seniority, days until the court date, and/or other preferences set by the attorneys. In other embodiments, the CDN computer device 110 submits 220 the ticket information to all of the attorneys and assigns the ticket to the attorney that responds first.

The attorney validates 222 the attorney fee estimate and the ticket information. If there are any issues, the CDN computer device 110 receives 224 the corrections of those issues from the attorney via the attorney computer device 125. The attorney can validate the ticket information and attorney fee estimate for errors, such as the wrong court or court date. These corrections may change the attorney fee estimate. Once the attorney has approved the ticket information and the attorney fee estimate, the CDN computer device 110 submits 226 the validated/final attorney fee estimate to the user. The CDN computer device 110 also stores the validated/final attorney fee and ticket information.

The user computer device 105 displays the validated/final attorney fee estimate to the user. The CDN computer device 110 can also transmit one or more notifications to the user to let the user know that the validated/final attorney fee estimate is ready for the user to review. The user can either decide to begin the legal relationship by providing a fee payment to pay the attorney fee estimate or the user can ignore or turn down representation via the user computer device 105. In the exemplary embodiment, the CDN computer device 110 receives 228 the fee payment via the payment services 130 (shown in FIG. 1). The payment services 130 route 230 and store the fee payment in a first account, such as an operating account. The attorney can then retrieve funds from the operating account as the work has been performed.

When the fee payment is received 228, the CDN computer device 110 notifies the attorney. The CDN computer device 110 generates 232 an attorney client agreement based on the final attorney fee estimate and the ticket information. In the exemplary embodiment, the database 120 stores one or more templates for the attorney client agreement. The CDN computer device 110 retrieves the appropriate template from the database 120. The CDN computer device 110 populates the template with information from the ticket information. The CDN computer device 110 submits 234 the attorney client agreement to the attorney for approval and/or signature via the attorney computer device 125. The CDN computer device 110 receives 236 the attorney approval on the attorney client agreement via the attorney computer device 125. In some embodiments, the attorney can make corrections and/or changes to the attorney client agreement prior to approving the attorney client agreement. In some embodiments, the CDN computer device 110 notifies the attorney when the fee payment has been received 228. In other embodiments, the CDN computer device 110 notifies the attorney when the attorney client agreement is ready for review.

Next, the CDN computer device 110 submits 238 the attorney client agreement to the user, via the user computer device 105, for signature. The CDN computer device 110 can also transmit one or more notifications to the user that the attorney client agreement is ready for review. The CDN computer device 110 receives 240 the user signature on the attorney client agreement. In some embodiments, the signature is an e-signature or other electronic signature. In other embodiments, the user prints out the attorney client agreement, signs it, and submits an image or scan of the signed agreement. In some embodiments, the attorney signs the attorney client agreement prior to submitting 238 the attorney client agreement to the user. In other embodiments, the attorney signs the attorney client agreement after receiving 240 the user signature.

Once the fee payment is received 228 and the user signature on the attorney client agreement is received 240, the engagement has begun and the attorney can begin work on the ticket (or other court documents). The CDN computer device 110 notifies the attorney that the user signature has been received. The CDN computer device 110 retrieves 242 the court entry information and prosecutor information from the database 120 and based on the jurisdiction information and ticket information. The court entry information informs the attorney of the guidelines for entering the court of the jurisdiction associated with the ticket. The CDN computer device 110 generates 224 a court entry filing for the attorney based on the court entry information. In some jurisdictions, the court entry filing may be a letter or form that the attorney may have to fill out. In these embodiments, the CDN computer device 110 retrieves a template from the database 120, populates the template with information from the ticket information and the court entry information, and submits the populated template to the attorney for review and signature. In other jurisdictions, the court entry may be an email to the court. In these embodiments, the CDN computer device 110 generates 244 the email with the ticket information and court entry information. The CDN computer device 110 then submits the email to the attorney for review and submission. The CDN computer device 110 can also notify the attorney that the court entry filing is ready for review. Another entry method can be by fax. However the court entry filing is generated 244 the CDN computer device 110 submits 246 the court entry filing. The CDN computer device 110 can submit 246 through an email, through an online portal, by printing out the required forms for mailing, and/or other methods as required.

The CDN computer device 110 uses the prosecutor information to generate 248 an initial contact request for the prosecutor. The initial contact request is based on the preferences of the prosecutor that have been stored in the database 120. In some embodiments, the CDN computer device 110 generates 248 an email to the prosecutor. In other embodiments, the CDN computer device 110 informs the attorney that the prosecutor would prefer a phone call or fax, along with the phone or fax number and other necessary information. The CDN computer device 110 can also instruct the attorney about the other information that may be required for the initial contact request, such as a copy of the ticket and/or the user's driving record. The CDN computer device 110 notifies the user that the initial contact request is ready for review.

In response to the initial contact request, the attorney and/or the CDN receive 250 a response from the prosecutor. The response from the prosecutor includes the fine amount and the court fees that the user would need to pay to resolve the ticket. The response information is stored by the CDN computer device 110 and associated with the record of the user. In some situations, there may be additional information in the response such as changes to the charge and actions that the user needs to take, such as attending traffic school. In the exemplary embodiment, the attorney reviews the response from the prosecutor prior to submitting the response 252 to the user. In other embodiments, the attorney receives the response from the prosecutor and enters the response (i.e., fine amount, court fees, etc.) into the CDN computer device 110 via the attorney computer device 125.

The CDN computer device 110 submits 252 the fine amount and court fees (and other information in the response) to the user via the user computer device 105. The CDN computer device 110 also notifies the user that the fine amount, court fees, and other information are ready for review. In some embodiments, the CDN computer device 110 submits 254 the fine amount, court fees, and other information in the response to the user computer device 105 via an email and/or text message. The CDN computer device 110 also stores the fine amount, court fees, and other information in the response in the database 120. The user can then access the response and/or information pertaining to the response via the user computer device 105 accessing the CDN computer device 110 and/or the CDN program 115.

At this point, the user may optionally pay their fine amount and/or court fees through the CDN computer device 110. In these embodiments, the payment services 130 receives 254 payment for the fine amount and/or the court fees from the user. The payment services 130 routes 256 the payment for the fine amount and court fees to a second account, where the second account is separate from the attorney's operating account (the first account). In some embodiments, the payment services 130 routes 258 the payment for the fine amount and court fees from the second account to the corresponding jurisdiction. In some embodiments, the payment services 130 routes 258 the payment from the second account to an account associated with the corresponding jurisdiction. In other embodiments, the payment services 130 routes 258 the payment to the jurisdiction through a web portal. In still other embodiments, the payment services 130 prints out a check to be mailed to the jurisdiction.

As noted above, the CDN computer device 110 repeatedly notifies the user and/or attorney that a step of process 200 is complete and the CDN computer device 110 is ready for the user or attorney to review one or more documents or perform one or more actions to move the process 200 along. In some embodiments, the CDN computer device 110 sends multiple reminder notifications on a periodic basis to the user and/or attorney to remind them that the CDN computer device 110 is waiting for them to perform an action and/or review a document. For example, the CDN computer device 110 could have different settings for reminders between the users and the attorneys. The attorneys could be set to have reminders send every 6 hours, while the users may only receive repeated reminders every 24 hours. These settings could also be set for individual attorneys. The user could also change their notification preferences.

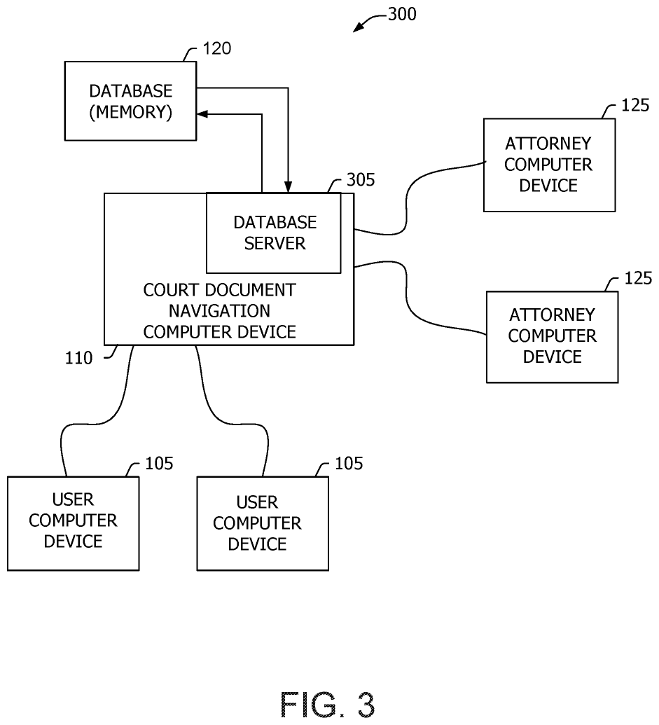

FIG. 3 illustrates another view of an enhanced court document navigation (CDN) system 300 in accordance with one embodiment of the disclosure.

The CDN system 300 includes a plurality of user computer devices 105 in communication with a court document navigation (“CDN”) computer device 110. The CDN computer device 110 is in communication with a database server 305 for retrieving and storing data in a database 120. The CDN computer device 110 is also in communication with one or more attorney computer devices 125 interface with the CDN computer device 110 and the plurality of user computer devices 105.

The CDN computer device 110 is programmed to receive a coordinate communications between the user on their user computer device 105 and the attorney using their attorney computer device 125. In the some embodiments, the CDN computer device 110 also provides an interface to one or more of payment services 130 and jurisdiction computer systems 135 (both shown in FIG. 1).

The CDN computer device 110 can also look up information about the court documents in question, the jurisdiction associated with the court documents, and any laws, guidelines, and/or rules associated with the court documents in question.

In the example, user computer devices 105 are computers that include a web browser or a software application, which enables user computer devices 105 to communicate with the CDN computer device 110 using the Internet, a local area network (LAN), or a wide area network (WAN). In some examples, the user computer devices 105 are communicatively coupled to the Internet through many interfaces including, but not limited to, at least one of a network, such as the Internet, a LAN, a WAN, or an integrated services digital network (ISDN), a dial-up-connection, a digital subscriber line (DSL), a cellular phone connection, a satellite connection, and a cable modem. User computer devices 105 can be any device capable of accessing a network, such as the Internet, including, but not limited to, a desktop computer, a laptop computer, a personal digital assistant (PDA), a cellular phone, a smartphone, a tablet, a phablet, or other web-based connectable equipment. In at least one example, one or more user computer devices 105 include a web browser that can be used to submit information to and request information from the CDN computer device 110.

The CDN computer device 110 includes at least one application executing on the CDN computer device 110 to perform the interfacing between systems and court document navigation, such as CDN program 115 (shown in FIG. 1). The application includes the document analysis algorithms and supporting software components. The application may be provided as a cloud-based web-service over the Internet or other network.

A database server 305 is communicatively coupled to a database 120 that stores data. In one example, the database 120 is a database that includes a plurality of jurisdiction information, a plurality of attorney fee calculation information, and a plurality of court document information. In some examples, the database 120 is stored remotely from the CDN computer device 110. In some examples, the database 120 is decentralized. In the example, a person can access the database 120 via the user computer device 105 or attorney computer device 125 by logging onto CDN computer device 110.

In the example, attorney computer devices 125 are computers that include a web browser or a software application, which enables the attorney computer devices 125 to communicate with the CDN computer device 110 using the Internet, a local area network (LAN), or a wide area network (WAN). In some examples, the attorney computer devices 125 are communicatively coupled to the Internet through many interfaces including, but not limited to, at least one of a network, such as the Internet, a LAN, a WAN, or an integrated services digital network (ISDN), a dial-up-connection, a digital subscriber line (DSL), a cellular phone connection, a satellite connection, and a cable modem. Attorney computer devices 125 can be any device capable of accessing a network, such as the Internet, including, but not limited to, a desktop computer, a laptop computer, a personal digital assistant (PDA), a cellular phone, a smartphone, a tablet, a phablet, or other web-based connectable equipment. The attorney computer devices 125 can be accessed by the CDN computer device 110 to submit information and document to be reviewed and signed by the attorney. Attorney computer devices 125 can include legal and jurisdiction information. Attorney computer devices 125 may access publically and/or privately available sources of information. Attorney computer devices 125 can be secured and encrypted to prevent unauthorized access of confidential and/or privileged information.

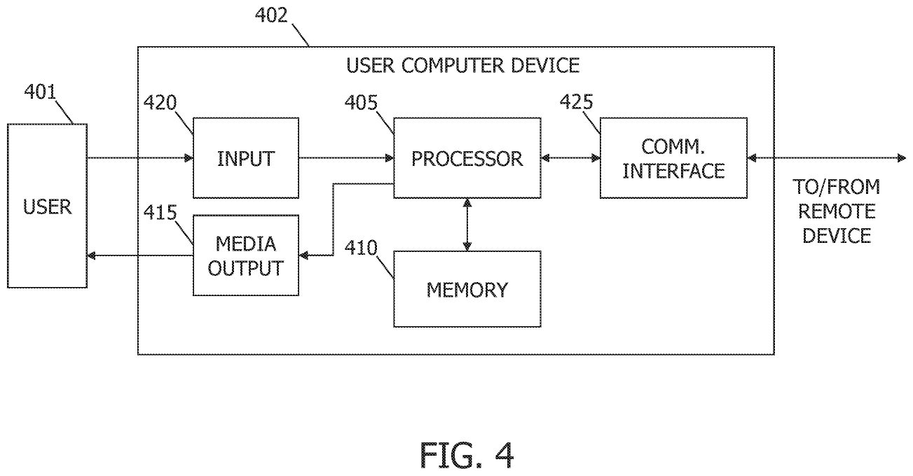

FIG. 4 illustrates an example configuration of a user computer device 402 used in the court document navigation system 100 (shown in FIG. 1) and the court document navigation system 300 (shown in FIG. 3), in accordance with one example of the present disclosure. User computer device 402 is operated by a user 401. The user computer device 402 can include, but is not limited to, the user computer device 105, the court document navigation computer device 110, the attorney computer device 125, and the jurisdiction computer systems 135 (all shown in FIG. 1). The user computer device 402 includes a processor 405 for executing instructions. In some examples, executable instructions are stored in a memory area 410. The processor 405 can include one or more processing units (e.g., in a multi-core configuration). The memory area 410 is any device allowing information such as executable instructions and/or transaction data to be stored and retrieved. The memory area 410 can include one or more computer-readable media.

The user computer device 402 also includes at least one media output component 415 for presenting information to the user 401. The media output component 415 is any component capable of conveying information to the user 401. In some examples, the media output component 415 includes an output adapter (not shown) such as a video adapter and/or an audio adapter. An output adapter is operatively coupled to the processor 405 and operatively coupleable to an output device such as a display device (e.g., a cathode ray tube (CRT), liquid crystal display (LCD), light emitting diode (LED) display, or “electronic ink” display) or an audio output device (e.g., a speaker or headphones). In some examples, the media output component 415 is configured to present a graphical user interface (e.g., a web browser and/or a client application) to the user 401. A graphical user interface can include, for example, an interface for viewing the information about a ticket or the ticket itself. In some examples, the user computer device 402 includes an input device 420 for receiving input from the user 401. The user 401 can use the input device 420 to, without limitation, select a ticket to review. The input device 420 can include, for example, a keyboard, a pointing device, a mouse, a stylus, a touch sensitive panel (e.g., a touch pad or a touch screen), a gyroscope, an accelerometer, a position detector, a biometric input device, and/or an audio input device. A single component such as a touch screen can function as both an output device of the media output component 415 and the input device 420.

The user computer device 402 can also include a communication interface 425, communicatively coupled to a remote device such as the court document navigation computer device 110 (shown in FIG. 1). The communication interface 425 can include, for example, a wired or wireless network adapter and/or a wireless data transceiver for use with a mobile telecommunications network.

Stored in the memory area 410 are, for example, computer-readable instructions for providing a user interface to the user 401 via the media output component 415 and, optionally, receiving and processing input from the input device 420. A user interface can include, among other possibilities, a web browser and/or a client application. Web browsers enable users, such as the user 401, to display and interact with media and other information typically embedded on a web page or a website from the court document navigation computer device 110. A client application allows the user 401 to interact with, for example, the court document navigation computer device 110. For example, computer-readable instructions can be stored by a cloud service, and the output of the execution of the computer-readable instructions sent to the media output component 415.

The processor 405 executes computer-executable instructions for implementing aspects of the disclosure.

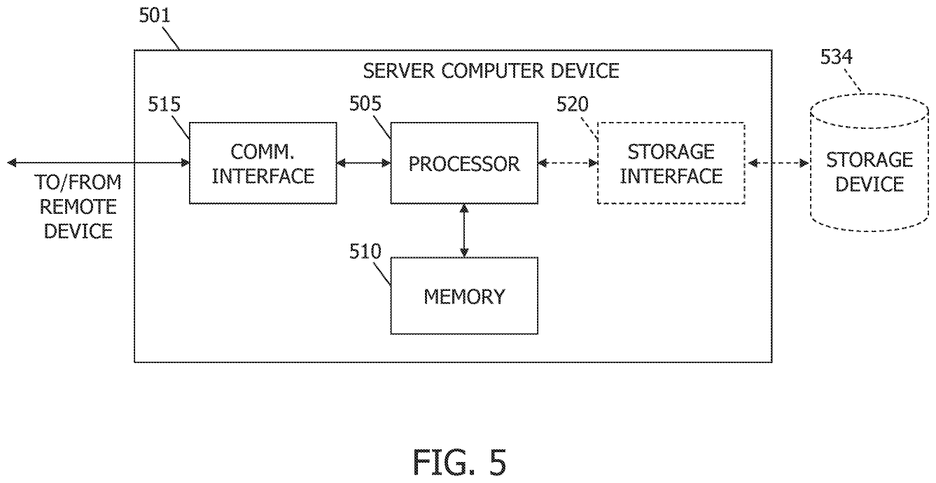

FIG. 5 illustrates an example configuration of a server computer device 501 used in the CDN system 100 (shown in FIG. 1) and the CDN system 300 (shown in FIG. 3), in accordance with one example of the present disclosure. Server computer device 501 can include, but is not limited to, the CDN computer device 110, the attorney computer device 125, the payment services 130, the jurisdiction computer systems 135 (all shown in FIG. 1), and the database server 305 (shown in FIG. 3). The server computer device 501 also includes a processor 505 for executing instructions. Instructions can be stored in a memory area 510. The processor 505 can include one or more processing units (e.g., in a multi-core configuration).

The processor 505 is operatively coupled to a communication interface 515 such that the server computer device 501 is capable of communicating with a remote device such as another server computer device 501, a CDN computer device 110, or a user computer device 105 (shown in FIG. 1). For example, the communication interface 515 can receive requests from the user computer device 105 via the Internet, as illustrated in FIGS. 1 and 3.

The processor 505 can also be operatively coupled to a storage device 534. The storage device 534 is any computer-operated hardware suitable for storing and/or retrieving data, such as, but not limited to, data associated with the database 120 (shown in FIG. 1). In some examples, the storage device 534 is integrated in the server computer device 501. For example, the server computer device 501 can include one or more hard disk drives as the storage device 534. In other examples, the storage device 534 is external to the server computer device 501 and can be accessed by a plurality of server computer devices 501. For example, the storage device 534 can include a storage area network (SAN), a network attached storage (NAS) system, and/or multiple storage units such as hard disks and/or solid state disks in a redundant array of inexpensive disks (RAID) configuration.

In some examples, the processor 505 is operatively coupled to the storage device 534 via a storage interface 520. The storage interface 520 is any component capable of providing the processor 505 with access to the storage device 534. The storage interface 520 can include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 505 with access to the storage device 534.

The processor 505 executes computer-executable instructions for implementing aspects of the disclosure. In some examples, the processor 505 is transformed into a special purpose microprocessor by executing computer-executable instructions or by otherwise being programmed. For example, the processor 505 is programmed with instructions such as those shown in FIGS. 2A-2C.

At least one of the technical solutions to the technical problems provided by this system may include: i) providing real-time access to the court systems to average users; ii) connecting an average individual access to an attorney; iii) providing direct interaction to a plurality of jurisdictions; iv) coordinating a plurality of individuals to access a plurality of jurisdictions; and v) coordinating access to attorneys for the individual.

The methods and systems described herein may be implemented using computer programming or engineering techniques including computer software, firmware, hardware, or any combination or subset thereof, wherein the technical effects may be achieved by performing at least one of the following steps: a) receive, from a user computer device, ticket information about a ticket and an image of the ticket; b) generate an attorney fee based on the ticket information; c) receive an indication of a fee payment from the user for the attorney fee via the user computer device; d) generate an attorney client agreement based on the ticket information; e) transmit, to the user computer device, the attorney client agreement to the user; f) receive, from the user computer device, a user signature on the attorney client agreement; g) generate a court entry filing for an attorney based on the ticket information; h) generate an initial contact request for the prosecutor based on the ticket information; i) submit, to the prosecutor, the initial contact request for the prosecutor; j) receive, from the prosecutor, a prosecutor response; k) transmit, via the user computer device, the prosecutor response to the user; l) compare the ticket information to the image of the ticket to detect one or more differences; m) present, via the user computer device, the one or more of the differences to the user; n) determine a fix for the one or more differences based on the comparison; o) present, via the user computer device, the fix to the user for confirmation; p) upon receiving confirmation from the user via the user computer device, update the ticket information based on the fix; q) retrieve, from a database, jurisdiction information based on the ticket information; r) generate an attorney fee estimate based on the ticket information and the jurisdiction information; s) determine one or more attorney actions based on the ticket information and the jurisdiction information; t) calculate a price for each of the one or more attorney actions; u) generate the attorney fee estimate to include the prices of the one or more attorney actions; v) transmit, to an attorney computer device, the attorney fee estimate to the attorney for approval; w) receive, from the attorney computer device, approval of the attorney fee estimate; x) receive, from the attorney computer device, one or more changes to the attorney fee estimate from the attorney; y) update the attorney fee estimate based on the one or more changes from the attorney; z) transmit, via an attorney computer device, a notification to the attorney that the fee payment has been received; aa) transmit, to an attorney computer device, the attorney client agreement to the attorney for approval; bb) receive, from the attorney computer device, an attorney signature from the attorney; cc) receive, via the attorney computer device, one or more changes to the attorney client agreement from the attorney; dd) update the attorney client agreement based on the one or more changes; ee) retrieve, from a database, jurisdiction information based on the ticket information; ff) retrieve court information and prosecutor information based on the jurisdiction information; gg) generate the court entry filing for the attorney based on the court information and the prosecutor information; hh) transmit, to an attorney computer device, the court entry filing to the attorney for review; ii) receive, from the attorney computer device, one or more changes to the court entry filing; jj) update the court entry filing based on the one or more changes; kk) transmit, to a court computer device, the court entry filing to the court associated with the jurisdiction information; ll) generate the initial contact request for the prosecutor based on the ticket information and the prosecutor information; mm) transmit, via an attorney computer device, the initial contact request for the prosecutor to the attorney for review; nn) receive, from the attorney computer device, one or more changes to the initial contact request for the prosecutor; oo) update the initial contact request for the prosecutor based on the one or more changes; pp) transmit, to a computer device associated with the processor, the initial contact request for the prosecutor; qq) receive, from the prosecutor, the prosecutor response, wherein the prosecutor response includes at least one of a fine amount, court fees, and one or more required user actions; rr) receive, from the user computer device, a payment for the fine amount; and ss) routing the payment for the fine amount to the jurisdiction associated with the ticket.

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium, such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps”, or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the term “database” may refer to either a body of data, a relational database management system (RDBMS), or to both. As used herein, a database may include any collection of data including hierarchical databases, relational databases, flat file databases, object-relational databases, object-oriented databases, and any other structured or unstructured collection of records or data that is stored in a computer system. The above examples are not intended to limit in any way the definition and/or meaning of the term database. Examples of RDBMS's include, but are not limited to, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, California; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

In another embodiment, a computer program is provided, and the program is embodied on a computer-readable medium. In an example embodiment, the system is executed on a single computer system, without requiring a connection to a server computer. In a further example embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of X/Open Company Limited located in Reading, Berkshire, United Kingdom). In a further embodiment, the system is run on an iOS® environment (iOS is a registered trademark of Cisco Systems, Inc. located in San Jose, Calif.). In yet a further embodiment, the system is run on a Mac OS® environment (Mac OS is a registered trademark of Apple Inc. located in Cupertino, Calif.). In still yet a further embodiment, the system is run on Android® OS (Android is a registered trademark of Google, Inc. of Mountain View, Calif.). In another embodiment, the system is run on Linux® OS (Linux is a registered trademark of Linus Torvalds of Boston, Mass.). The application is flexible and designed to run in various different environments without compromising any major functionality.

In some embodiments, the system includes multiple components distributed among a plurality of computer devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes. The present embodiments may enhance the functionality and functioning of computers and/or computer systems.

As used herein, an element or step recited in the singular and preceded by the word “a” or “an” should be understood as not excluding plural elements or steps, unless such exclusion is explicitly recited. Furthermore, references to “example embodiment,” “exemplary embodiment,” or “one embodiment” of the present disclosure are not intended to be interpreted as excluding the existence of additional embodiments that also incorporate the recited features.

Furthermore, as used herein, the term “real-time” refers to at least one of the time of occurrence of the associated events, the time of measurement and collection of predetermined data, the time to process the data, and the time of a system response to the events and the environment. In the embodiments described herein, these activities and events occur substantially instantaneously.

The patent claims at the end of this document are not intended to be construed under 35 U.S.C. § 112(f) unless traditional means-plus-function language is expressly recited, such as “means for” or “step for” language being expressly recited in the claim(s).

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A court document navigation (CDN) computer device comprising at least one processor in communication with at least one memory device, the at least one processor programmed to:
receive, from a user computer device, ticket information about a ticket and an image of the ticket;
generate an attorney fee based on the ticket information;
receive an indication of a fee payment from the user for the attorney fee via the user computer device;
generate an attorney client agreement based on the ticket information;
transmit, to the user computer device, the attorney client agreement to the user;
receive, from the user computer device, a user signature on the attorney client agreement;
generate a court entry filing for an attorney based on the ticket information;
generate an initial contact request for the prosecutor based on the ticket information;
submit, to the prosecutor, the initial contact request for the prosecutor;
receive, from the prosecutor, a prosecutor response; and
transmit, via the user computer device, the prosecutor response to the user.

2. The CDN computer device in accordance with claim 1, wherein the at least one processor is further programmed to:
compare the ticket information to the image of the ticket to detect one or more differences; and
present, via the user computer device, the one or more of the differences to the user.

3. The CDN computer device in accordance with claim 2, wherein the at least one processor is further programmed to:
determine a fix for the one or more differences based on the comparison;
present, via the user computer device, the fix to the user for confirmation; and
upon receiving confirmation from the user via the user computer device, update the ticket information based on the fix.

4. The CDN computer device in accordance with claim 1, wherein the at least one processor is further programmed to:
retrieve, from a database, jurisdiction information based on the ticket information; and
generate an attorney fee estimate based on the ticket information and the jurisdiction information.

5. The CDN computer device in accordance with claim 4, wherein the at least one processor is further programmed to generate the attorney fee estimate by:
determine one or more attorney actions based on the ticket information and the jurisdiction information;
calculate a price for each of the one or more attorney actions; and
generate the attorney fee estimate to include the prices of the one or more attorney actions.

6. The CDN computer device in accordance with claim 5, wherein the at least one processor is further programmed to:
transmit, to an attorney computer device, the attorney fee estimate to the attorney for approval; and
receive, from the attorney computer device, approval of the attorney fee estimate.

7. The CDN computer device in accordance with claim 6, wherein the at least one processor is further programmed to:
receive, from the attorney computer device, one or more changes to the attorney fee estimate from the attorney; and
update the attorney fee estimate based on the one or more changes from the attorney.

8. The CDN computer device in accordance with claim 1, wherein the at least one processor is further programmed to transmit, via an attorney computer device, a notification to the attorney that the fee payment has been received.

9. The CDN computer device in accordance with claim 1, wherein the at least one processor is further programmed to:
transmit, to an attorney computer device, the attorney client agreement to the attorney for approval; and
receive, from the attorney computer device, an attorney signature from the attorney.

10. The CDN computer device in accordance with claim 9, wherein the at least one processor is further programmed to:
receive, via the attorney computer device, one or more changes to the attorney client agreement from the attorney; and
update the attorney client agreement based on the one or more changes.

11. The CDN computer device in accordance with claim 1, wherein the at least one processor is further programmed to:
retrieve, from a database, jurisdiction information based on the ticket information;
retrieve court information and prosecutor information based on the jurisdiction information; and
generate the court entry filing for the attorney based on the court information and the prosecutor information.

12. The CDN computer device in accordance with claim 11, wherein the at least one processor is further programmed to:
transmit, to an attorney computer device, the court entry filing to the attorney for review;
receive, from the attorney computer device, one or more changes to the court entry filing; and
update the court entry filing based on the one or more changes.

13. The CDN computer device in accordance with claim 11, wherein the at least one processor is further programmed to transmit, to a court computer device, the court entry filing to the court associated with the jurisdiction information.

14. The CDN computer device in accordance with claim 11, wherein the at least one processor is further programmed to generate the initial contact request for the prosecutor based on the ticket information and the prosecutor information.

15. The CDN computer device in accordance with claim 11, wherein the at least one processor is further programmed to:
transmit, via an attorney computer device, the initial contact request for the prosecutor to the attorney for review;
receive, from the attorney computer device, one or more changes to the initial contact request for the prosecutor; and
update the initial contact request for the prosecutor based on the one or more changes.

16. The CDN computer device in accordance with claim 1, wherein the at least one processor is further programmed to transmit, to a computer device associated with the processor, the initial contact request for the prosecutor.

17. The CDN computer device in accordance with claim 1, wherein the at least one processor is further programmed to receive, from the prosecutor, the prosecutor response, wherein the prosecutor response includes at least one of a fine amount, court fees, and one or more required user actions.

18. The CDN computer device in accordance with claim 17, wherein the ticket is associated with a jurisdiction, wherein the at least one processor is further programmed to:
receive, from the user computer device, a payment for the fine amount; and
routing the payment for the fine amount to the jurisdiction associated with the ticket.

19. A method for navigating court documents implemented by at least one processor in communication with at least one memory device, the method comprises:
receiving, from a user computer device, ticket information about a ticket and an image of the ticket;
generating an attorney fee based on the ticket information;
receiving an indication of a fee payment from the user for the attorney fee via the user computer device;
generating an attorney client agreement based on the ticket information;
transmitting, to the user computer device, the attorney client agreement to the user;
receiving, from the user computer device, a user signature on the attorney client agreement;
generating a court entry filing for an attorney based on the ticket information;
generating an initial contact request for the prosecutor based on the ticket information;
submitting, to the prosecutor, the initial contact request for the prosecutor;
receiving, from the prosecutor, a prosecutor response; and
transmitting, via the user computer device, the prosecutor response to the user.

20. A system comprising:
a user computer device comprising a processor in communication with a memory device;
an attorney computer device comprising a processor in communication with a memory device;
a database including jurisdiction information; and
a court document navigation (CDN) computer device comprising a processor in communication with a memory, wherein the CDN computer device is in communication with the user computer device, the attorney computer device, and the database, and wherein the processor of the CDN computer device is programmed to:
receive, from the user computer device, ticket information about a ticket and an image of the ticket;
retrieve, from the database, jurisdiction information based on the ticket information;
generate an attorney fee based on the ticket information and the jurisdiction information;
receive an indication of a fee payment from the user for the attorney fee via the user computer device;
generate an attorney client agreement based on the ticket information;
transmit, to the attorney computer device, the attorney client agreement to an attorney;
receive, from the attorney computer device, an attorney signature on the attorney client agreement;
transmit, to the user computer device, the attorney client agreement to the user;
receive, from the user computer device, a user signature on the attorney client agreement;
generate a court entry filing for the attorney based on the ticket information;
generate an initial contact request for the prosecutor based on the ticket information;
submit, to the prosecutor, the initial contact request for the prosecutor;
receive a prosecutor response; and
transmit, via the user computer device, the prosecutor response to the user.
